(19) United States
(12) Patent Application Publication
(10) Pub. No.: US 2005/0198146 A1
(43) Pub. Date: Sep. 8, 2005

(54) System and method for targeted notifications tracking

(75) Inventors: Srinivas Chowdhury, Temple, TX (US); Joseph Samake, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 10/757,655

(22) Filed: Jan. 14, 2004

(51) Int. Cl. G06F 15/16

(52) U.S. Cl. 709/206

(57) ABSTRACT

An example of a solution provided here comprises parsing stored information, and automatically sending at least one customized message; components of the customized message are derived from the parsing. Another example comprises extracting message components from stored information, creating a customized message, based on a recipient's role in a project, and automatically sending the customized message to the recipient, wherein the customized message contains the message components, the stored information contains information concerning the project; and the recipient is a person responsible for at least part of the project.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to communications and information handling, and more particularly to methods and systems involving tracking, notification, and customized messages.

### BACKGROUND OF THE INVENTION

In many situations, persons need to be notified of changing conditions. This is true of persons working on a project, for example. Each person may need to be notified of different conditions. The changing conditions may be contained in a large collection of information, like a database, table or schedule. However, it can be very inefficient to communicate such a large collection of information to each person, and to have each person search it. Various approaches have been proposed for scheduling events, and communicating calendars or schedules. These examples do not communicate information that is customized for various users. Thus there is a need for systems and methods of targeted notification.

### SUMMARY OF THE INVENTION

An example of a solution to problems mentioned above comprises parsing stored information, and automatically sending at least one customized message; components of the customized message are derived from the parsing. Another example comprises extracting message components from stored information, creating a customized message, based on a recipient's role in a project, and automatically sending the customized message to the recipient, wherein the customized message contains the message components, the stored information contains information concerning the project; and the recipient is a person responsible for at least part of the project.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a block diagram illustrating a simplified example of a system and method of Targeted Notifications Tracking (TNT).

FIG. 3 is a flow chart illustrating an example of a process of Targeted Notifications Tracking.

FIG. 4 illustrates an example implementation that uses a spreadsheet and email messages.

FIG. 5 illustrates an example of stored information in a table or spreadsheet format.

### DETAILED DESCRIPTION

The examples that follow involve the use of one or more computers and may involve the use of one or more communications networks, or the use of various devices capable of handling messages, such cell phones or two-way pagers. The present invention is not limited as to the type of computer or device on which it runs, and not limited as to the type of network used.

The following are definitions of terms used in the description of the present invention and in the claims:
“Application” means any specific use for computer technology, or any software that allows a specific use for computer technology.
“Client” means any application that requests or utilizes a service. Examples of such a service include but are not limited to: information services, transactional services, access to databases, and access to audio or video content.
“Client-server application” means any application involving a client that utilizes a service, and a server that provides a service. Examples of such a service include but are not limited to: information services, transactional services, access to databases, and access to audio or video content.

“Component” means any element or part, and may include elements consisting of hardware or software or both.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Customized” means adapted, adjusted or tuned.

“Defect” means any event or feature that may be unexpected, undesirable, or incorrect.

“Dependency” refers to any condition where certain data, files, hardware, or software are required for proper performance, or completion of a task.

“Mapping” means associating, matching or correlating.

“Output” or “Outputting” means producing, transmitting, or turning out in some manner, including but not limited to printing on paper, or displaying on a screen, writing to a disk, or using an audio device.

“Parse” means to analyze or break down.

“Project” means any assignment, enterprise, job, undertaking or venture, in any industry or profession; for example, it may involve providing services, or a mixture of goods and services.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Targeted Notifications Tracking” (TNT) refers to any automated solution involving tracking, notification, and customized messages targeted to specific recipients.

“Web application” means any application utilizing a web browser or hypertext transfer protocol (HTTP).

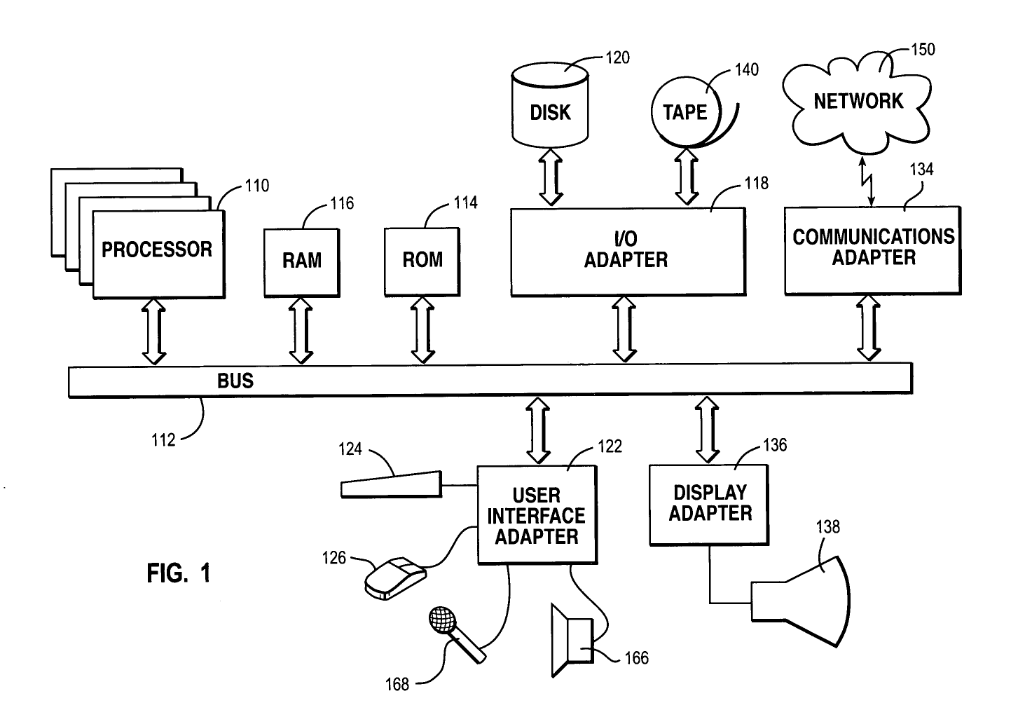

FIG. 1 illustrates a simplified example of an information handling system that may be used to practice the present invention. The invention may be implemented on a variety of hardware platforms, including embedded systems, cell phones, two-way pagers, hand-held computers, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

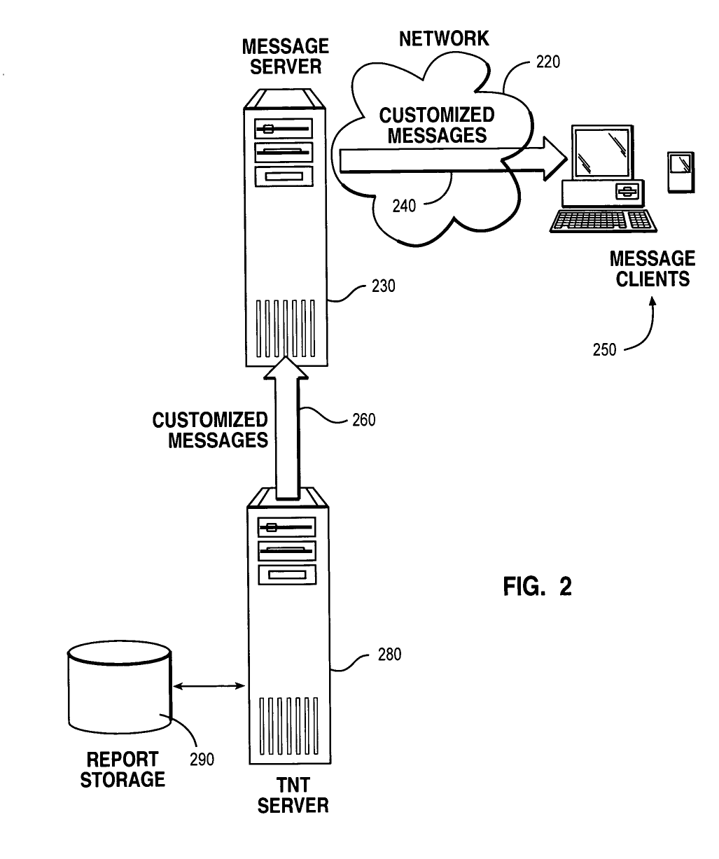

FIG. 2 is a block diagram illustrating a simplified example of a system and method of Targeted Notifications Tracking (TNT). To begin with an overview, TNT server 280 represents any computer that a TNT application runs on. A user such as a manager communicates with other users, through TNT server 280, customized messages (message path shown by arrows 260 and 240), message server 230, network 220 and message clients 250. Message clients at 250 may comprise any software and hardware capable of handling messages. The users may be involved in marketing, construction, information technology, or some other field.

Consider the following scenario where targeted notifications tracking may be useful. Sheila manages a large software project that involves 30 software developers. The project has 5 different modules, each owned by a team of 6 developers. At the beginning of the project, Sheila identifies several dependencies for each of the teams. She then proceeds set up a dependency meeting, where various dependencies are discussed and tracked. She further creates a mailing list with all the developers on it. Each week she sends out a spreadsheet to all the participants with the latest status information on each dependency. As time progresses, several dependencies are closed, and the developers responsible for those no longer need to attend a dependency meeting, nor be on the list to receive the spreadsheet update. But Sheila is a very busy, and she does not have time clean up her list. This would imply keeping track of who needs to be sent the spread sheet. So all 30 developers still receive the e-mail notifications with a huge spread sheet attachment, for issues that only concern 5 of the developers. Furthermore, there is a significant loss of productivity for developers who have to scan the entire spreadsheet each time, to find out whether they are responsible for any open issues. This can lead, in some instances, to the developers ignoring the whole spreadsheet.

However, consider how Sheila may use a system and method of targeted notifications tracking like the one shown in FIG. 2. Sheila may use a TNT application, running on TNT server 280. Sheila updates her spreadsheet to show which dependencies are closed, following a predetermined format, and runs it through the TNT application at 280. The TNT application at 280 parses the spreadsheet, and sends out customized messages at 260. Only the developers with open dependencies receive the customized messages 240, via the message clients 250 and network 220. The customized messages 240 include only relevant information.

The following are some possible advantages of utilizing a system and method of targeted notifications tracking like the one shown in FIG. 2. There may be significant increases in productivity for all persons involved in a project, relative to the earlier scenario. Each individual will be able to focus on issues for which he or she is accountable. There may be better accountability, because the proper parties are systematically and properly notified of issues requiring their attention. Traffic in network 220 decreases, relative to the earlier scenario, because customized messages 240 are targeted only at the proper users. Users will receive only information pertaining to issues that they are directly involved with. People involved with the project attend to issues, and attend meetings, only as needed, based upon customized messages 240.

TNT server 280 may serve as a means for parsing stored information at 290. TNT server 280, message server 230, network 220, and message clients at 250 may serve as means for automatically sending customized messages shown at 260 and 240. Components of customized messages are derived from parsing performed by TNT server 280. A storage device at 290 and TNT server 280 may serve as means for storing and updating information. TNT server 280 may serve as means for extracting from stored information at 290 message components such as message recipients, message subjects and message content. Storage component 290 and TNT server 280 may serve as means for creating customized messages at 260. Creating customized messages 260 may be based on the role of a recipient at 250. For example each customized message at 260 maybe based on a row in a table stored at 290. Customized messages shown at 260 and 240 preferably have content limited to a problem for which a recipient, using one of the message clients at 250, is responsible.

Preferably, the process of sending customized messages 240 should be automated, and stored information (report storage 290) should be kept current.

Continuing with details that may be involved in FIG. 2, extensible markup language (XML), provides a way of containing and managing information that is designed to handle data exchange among various data systems. Thus it is well-suited to implementation of the present invention. Reference is made to the book by Elliotte Rusty Harold and W. Scott Means, XML in a Nutshell (O'Reilly & Associates, 2001). As a general rule, XML messages use “attributes” to contain information about data, and “elements” to contain the actual data.

In this example, the TNT application at 280 may be implemented with the JAVA programming language for example, and thus it is independent of any particular operating system. The parsing performed by the TNT application at 280 may be implemented with a scripting language such as PERL or PHP, for example, both of which are independent of any particular operating system.

Sending messages at 240 may comprise utilizing one or more communication technologies. Message server 230, network 220 and message clients 250 represent means for utilizing one or more communication technologies, such as e-mail, text-to-speech, voice mail, voice over IP, wireless text messages, instant messaging, short message services, and posting on a web site (using content pushed to web sites). Wireless text messages may be implemented with JAVA Standard Micro Edition, for example. The utilization of e-mail protocols may be accomplished with the JAVAMAIL application programming interface (API). The JAVAMAIL API Design Specification is freely available from Sun Microsystems, Inc., and includes source code for creating and sending e-mail messages.

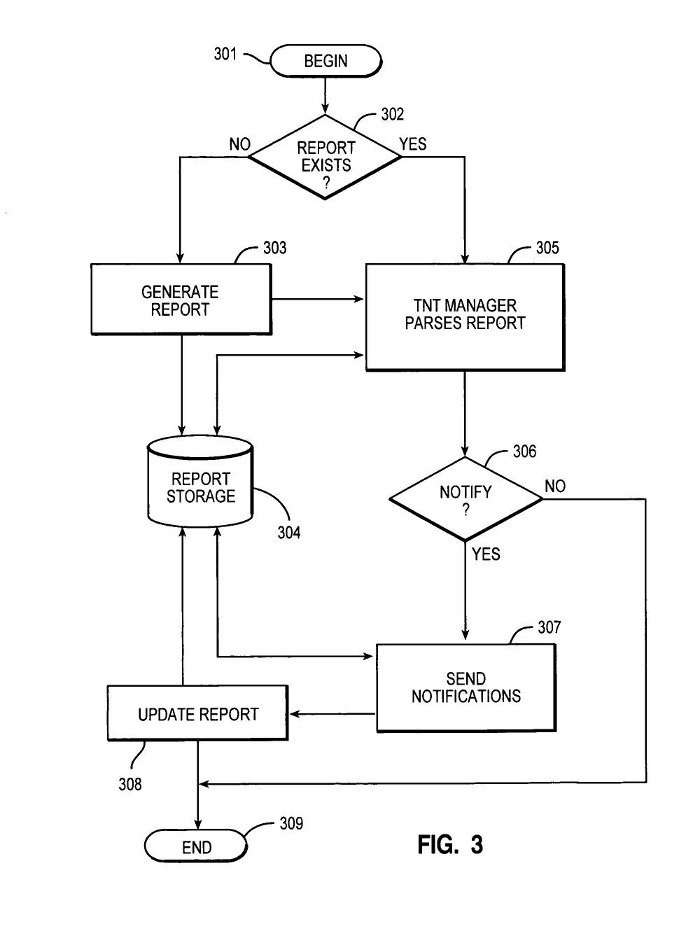

FIG. 3 is a flow chart illustrating an example of a process of Targeted Notifications Tracking. This is an example of one TNT iteration. Block 301 represents the start of a TNT process. A project effort of some sort is started. Decision block 302 represents determining whether stored information exists for the project. For example, has the project manager created a report consolidating the various project artifacts to be tracked? If such a report exists, then TNT uses it as an input (the “Yes” branch is taken to 305), or else the report is created (the “No” branch is taken to 303).

Block 303 represents creating a collection of information, such as a report to track project activities. For example, the project manager identifies tasks, roles, responsibilities, dependencies, defects, deadlines, etc., and consolidates a report to keep track of individual components of a project. For example, the report can be generated in a spreadsheet format, identifying the component and the characteristics of the component from a project management perspective (owner, contact info, deadline, dependency, defects, etc.). The process may proceed to block 305 after the information is stored (symbolized by arrow connecting to block 304). Block 304 represents storing information. For example, the generated tracking report can be stored in a file, database or some kind of storage medium.

Block 305 represents invoking the TNT manager or TNT application. The TNT application may be run in an interactive mode, or in an automated, scheduled job mode. It reads the report from the storage medium (symbolized by double-headed arrow connecting to block 304). The data is parsed according to a registered protocol, and a determination is made as to who needs to be notified, with what information. At decision block 306, TNT determines whether new notifications need to be sent out. If so, the “Yes” branch is taken to 307, or else the process ends (the “No” branch is taken to 309).

Block 307 represents TNT creating and sending out customized notification messages, using any protocol (e.g., e-mail, page, etc.). This may involve extracting from the stored information (symbolized by double-headed arrow connecting to block 304) one or more message components such as message recipients, message subjects, and message contents. Messages are sent automatically; a user need not compose and send messages one at a time.

Block 308 represents updating the report, and filing a log of activity (symbolized by arrow connecting to block 304). Block 308 represents one possible point in the process where stored information may be updated. For example, a new description of a defect may be received and added to stored information. Block 309 represents the end of one TNT iteration.

Regarding FIG. 3, the order of the operations described above may be varied. For example, it is within the practice of the invention for there to be a point early in the process where stored information may be updated, perhaps between decision 302 and block 305. Blocks in FIG. 3 could be arranged in a somewhat different order, but still describe the invention. Blocks could be added to the above-mentioned diagram to describe details, or optional features; some blocks could be subtracted to show a simplified example.

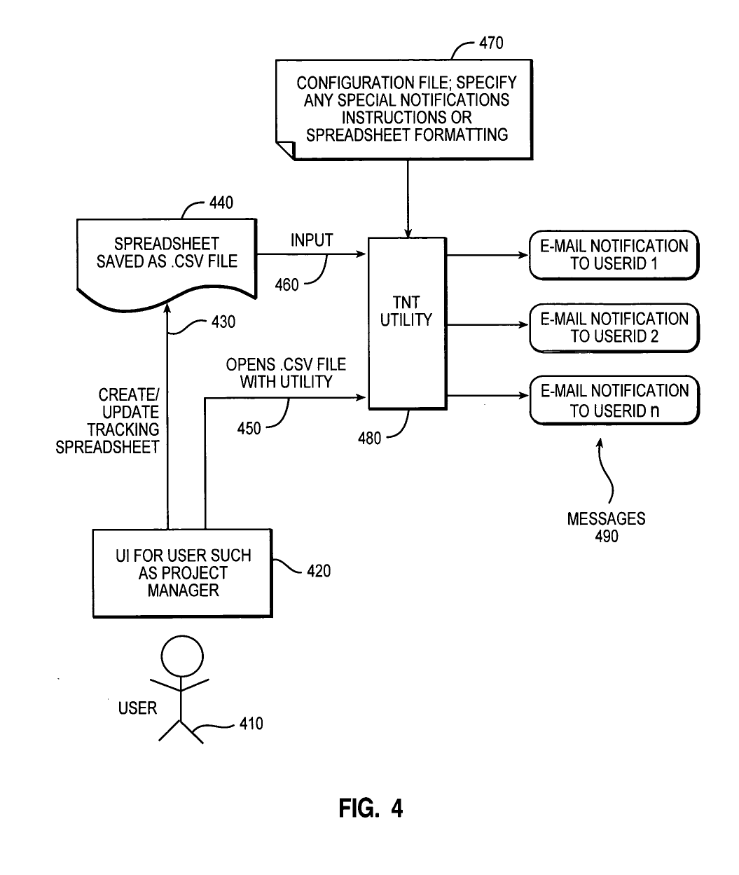

FIG. 4 illustrates an example implementation that uses a spreadsheet and email messages. The user at 410 represents a user such as a project manager, who communicates with other users, through a TNT application (TNT utility 480) and messages at 490. The example described here uses e-mail messages at 490. Sending messages at 490 may comprise utilizing one or more communication technologies, such as e-mail, text-to-speech, voice mail, voice over IP, wireless text messages, instant messaging, short message service, and posting on a web site. The user at 410 creates and updates (arrow 430) a spreadsheet 440 to show which problems are closed (i.e. solved) and which problems are open (i.e. unsolved).

Regarding user interface (UI) 420, the TNT utility 480 could be invoked with a graphical user interface (GUI), or TNT utility 480 may be run as a command—line application. The TNT utility 480 may be run in an interactive mode, or in an automated, scheduled job mode. Another possibility would be to implement it as a web application (i.e., a computer application executable over an intranet or the Internet).

Regarding the input 460 for the TNT utility 480, the stored information is described as a spreadsheet saved as a comma-separated value (CSV) file at 440. (Comma-separated value refers to an ASCII file where each individual data field is separated by commas.) However, the stored information could have any one of several formats such as XML. Alternatively, the input information could be stored as a database structure. The user at 410 may provide input 460 for the TNT utility 480 by opening (arrow 450) spreadsheet 440 with the TNT utility 480.

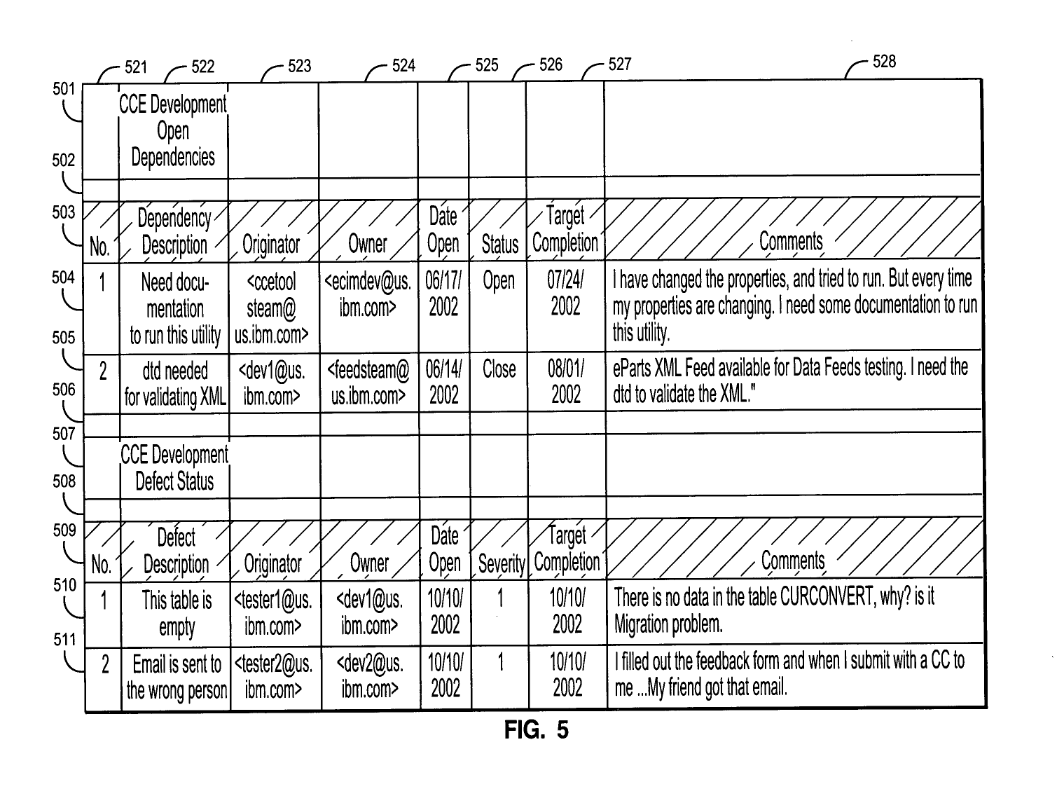

The TNT utility 480 accounts for special notification message instructions or formatting through configuration file 470. (See the sample TNT configuration file below, in the discussion of FIG. 5.) The configuration file could have any one of multiple formats, such as a simple properties file, XML, or some other proprietary format.

FIG. 5 illustrates an example of stored information in a table or spreadsheet format (for a hypothetical project called “CCE”). FIG. 5 shows examples of message components to be extracted, such as:
Message recipients (recipients' email addresses in column 524),
Message subjects (the subject lines may be extracted from column 522),
Message contents (comments in column 528 may be included in the body of the email message. Additional content may be specified. See for example the “Additional body” line in the sample configuration file below),
Dependency information (in column 522, rows 501-505), or

Defect information (in column 522, rows 507-511).

Each problem or issue is shown in its own row (see rows 504-505, and rows 510 -511). FIG. 5 shows examples (in rows 504-505, and rows 510-511) of how storing information may comprise mapping a problem to at least one person responsible for solving the problem. For example, row 510 matches a problem (described in columns 522 and 528: “This table is empty . . . There is no data in the table . . . .”) to a person or group who is responsible for solving the problem (i.e. the owner, identified by the email address <dev1@us.ibm.com> in column 524).

FIG. 5 shows examples of useful tracking information specific to each issue, such as severity or status information (see column 526) and dates (see columns 525 and 527).

The spreadsheet in FIG. 5, when stored in CSV format, looks like this:
“CCE Development Open Dependencies”
“No.”, “Dependency Description”, “Originator”, “Owner”, “Date Open”, “Status”, “Target Completion”, “Comments”
,“Need documentation to run this utility”, “<ccetoolsteam@us.ibm.com>”, “<ecimdev@us.ibm.com>”, 06/17/2002, “Open”, 07/24/2002, “I have changed the properties, and tried to run. But every time my properties are changing. I need some documentation to run this utility.”
2, “dtd needed for validating XML”, “<dev1@us.ibm.com>”, “<feedsteam@us.ibm.com>”, 06/14/2002, “Close”, 08/01/2002, “eParts XML Feed available for Data Feeds testing. I need the dtd to validate the XML.
“CCE Development Defect Status”
“No”, “Defect Description”, “Originator”, “Owner”, “Date Open”, “Severity”, “Target Completion”, “Comments”, 1, “This table is empty”, “<tester1@us.ibm.com>”, “<dev1@us.ibm.com>”, 10/10/2002, 1, 10/10/2002, “There is no data in the table CURCONVERT, why? is it Migration problem.”
2, “Email is sent to the wrong person”, “<tester2@us.ibm.com>”, “<dev2@us.ibm.com>”, 10/10/2002, 1, 10/10/2002, “I filled out the feedback form and when I submit with a CC to me . . . My friend got that e-mail.”

Continuing with details of the example in FIG. 5, the TNT protocol defines a predetermined arrangement for the columns in the spreadsheet (this is configurable). Following that protocol, TNT parses the CSV file and extracts the e-mail ID's (recipients' email addresses in column 524): for parties to be notified for each dependency or defect. Dependencies or defects usually involve 2 parties: an originator (see email addresses in column 523) who finds or reports the problem, and an owner (see email addresses in column 524) who owns the resolution of the problem. Those email notification messages may be sent using the JavaMail standard, for example. TNT also extracts from the spreadsheet or CSV file the comments (see column 528) or status information (see column 526) specific to each issue and includes that in the body of the notification message, thus avoiding attachment of the whole spreadsheet with each email message.

TNT accounts for special notification message instructions through a configuration file. See the sample TNT configuration file below:
# This is a configuration file to set up different configuration options
# for parsing and the notification message process
SMTP_MAIL_SERVER=us.ibm.com;
# The following ID used to send the e-mail message and cc's
FROM_EMAIL=ccepm@us.ibm.com;
# Additional copies for managers
FROM_EMAIL_CC=ccebam@us.ibm.com;
# This is the subject line
EMAIL_SUBJECT=COLUMN2;
# Person who opened the defect or dependency
ORIGINATOR_EMAIL=COLUMN3;
# Owner of the dependency or defect
OWNER_EMAIL=COLUMN4;
# Send e-mail message only if this condition satisfies. Conditions are set in column 6, and an e-mail message will be sent only if the value of column 6 is Open. Leave it blank if an e-mail message has to be sent without any condition.
EMAIL_CONDITION=COLUMN6_Open;
# Body of the e-mail message from the spreadsheet
EMAIL_BODY=COLUMN8
# Additional body
ADDITIONAL_EMAIL_BODY=This dependency or defect was opened against you. Can you please take specific action and give me a status by tomorrow morning.;
# email signature of project manager (PM)
EMAIL_SIGNATURE=CCE Development PM
Continuing with details of FIG. 5, consider the sample email message below, based on row 504:
   TO: <ecimdev@us.ibm.com>
   CC: <ccetoolsteam@us.ibm.com>
   SUBJECT: Need documentation to run this utility
   Hi,
   This dependency or defect was opened against you. Can you please take specific action and give me a status by tomorrow morning.
   ccetoolsteam->I have changed the properties, and tried to run. But every time my properties are changing. I need some documentation to run this utility.
   Thank you.
   CCD Development PM

FIG. 5, together with the sample email message, show examples of:
creating a customized message, based on a recipient's role in a project.
creating a customized message, based on a row in a table.
creating a customized message, with content limited to a problem for which a recipient is responsible.

In conclusion, we have shown examples of systems and methods of targeted notification.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

1. A method of communication, said method comprising:
parsing stored information; and
automatically sending at least one customized message;
wherein components of said customized message are derived from said parsing.

2. The method of claim 1, further comprising:
storing said information; and
updating said information.

3. The method of claim 2, wherein said storing further comprises:
mapping a problem to at least one person responsible for solving said problem.

4. The method of claim 1, wherein said parsing further comprises:
extracting from said stored information one or more message components chosen from
message recipients,
message subjects, and
message contents.

5. The method of claim 1, wherein said parsing further comprises:
extracting from said stored information
dependency information, or
defect information,
or both.

6. The method of claim 1, wherein said sending further comprises utilizing one or more communication technologies chosen from
e-mail,
text-to-speech,
voice mail,
voice over IP,
wireless text messages,
instant messaging,
short message services,
and posting on a web site.

7. The method of claim 1, wherein said at least one customized message is sent to a person responsible for at least part of a project; and
wherein said stored information contains information concerning said project.

8. The method of claim 1, further comprising:
creating said customized message, based on a recipient's role in a project.

9. The method of claim 1, further comprising:
creating said customized message, based on a row in a table.

10. The method of claim 1, further comprising:
creating said customized message, with content limited to a problem for which a recipient is responsible.

11. A method of communication, said method comprising:
extracting message components from stored information;
creating a customized message, based on a recipient's role in a project; and
automatically sending said customized message to said recipient;
wherein said customized message contains said message components;
wherein said stored information contains information concerning said project; and
wherein said recipient is a person responsible for at least part of said project.

12. The method of claim 11, further comprising:
storing said information; and
updating said information.

13. The method of claim 12, wherein said storing further comprises:
mapping a problem to at least one person responsible for solving said problem.

14. The method of claim 11, where in said extracting further comprises:
extracting from said stored information one or more message components chosen from
message recipients,
message subjects,
message contents.

15. The method of claim 11, wherein said extracting further comprises:
extracting from said stored Information
dependency information, or
defect information,
or both.

16. The method of claim 1 1, wherein said sending further comprises utilizing one or more communication technologies chosen from
e-mail,
text-to-speech,
voice mail,
voice over IP,
wireless text messages,
instant messaging,
short message services,
and posting on a web site.

17. A system of communication, said system comprising:
means for parsing stored information; and
means for automatically sending at least one customized message;
wherein components of said customized message are derived from said means for parsing.

18. The system of claim 17, further comprising:
means for storing said information; and
means for updating said information.

19. The system of claim 18, wherein said means for storing further comprises:
means for mapping a problem to at least one person responsible for solving said problem.

20. The system of claim 17, wherein said means for parsing further comprises:
means for extracting from said stored information one or more message components chosen from
message recipients,
message subjects, and
message contents.

21. The system of claim 17, wherein said means for parsing further comprises:
means for extracting from said stored information
dependency information, or
defect information,
or both.

22. The system of claim 17, wherein said means for sending further comprises means for utilizing one or more communication technologies chosen from
e-mail,
text-to-speech,
voice mail,
voice over IP,
wireless text messages,
instant messaging,
short message services,
and posting on a web site.

23. The system of claim 17, wherein said at least one customized message is sent to a person responsible for at least part of a project; and
wherein said stored information contains information concerning said project.

24. The system of claim 17, further comprising:
means for creating said customized message, based on a recipient's role in a project.

25. The system of claim 17, further comprising:
means for creating said customized message, based on a row in a table.

26. The system of claim 17, further comprising:
means for creating said customized message, with content limited to a problem for which a recipient is responsible.

27. A computer-usable medium, having computer-executable instructions for communication, said computer-usable medium comprising:
means for parsing stored information; and
means for automatically sending at least one customized message;
wherein components of said customized message are derived from said means for parsing.

28. The computer-usable medium of claim 27, further comprising:
means for storing said information; and
means for updating said information.

29. The computer-usable medium of claim 28, wherein said means for storing further comprises:
means for mapping a problem to at least one person responsible for solving said problem.

30. The computer-usable medium of claim 27, wherein said means for parsing further comprises:
means for extracting from said stored information one or more message components chosen from
message recipients,
message subjects, and
message contents.

31. The computer-usable medium of claim 27, wherein said means for parsing further comprises:
means for extracting from said stored information
dependency information, or
defect information,
or both.

32. The computer-usable medium of claim 27, wherein said means for sending further comprises means for utilizing one or more communication technologies chosen from
e-mail,
text-to-speech,
voice mail,
voice over IP,
wireless text messages,
instant messaging,
short message services,
and posting on a web site.

33. The computer-usable medium of claim 27, wherein said at least one customized message is sent to a person responsible for at least part of a project; and
wherein said stored information contains information concerning said project.

34. The computer-usable medium of claim 27, further comprising:
means for creating said customized message, based on a recipient's role in a project.

35. The computer-usable medium of claim 27, further comprising:
means for creating said customized message, based on a row in a table.

36. The computer-usable medium of claim 27, further comprising:
means for creating said customized message, with content limited to a problem for which a recipient is responsible.
